(19) United States
(12) Patent Application Publication
(10) Pub. No.: US 2021/0139672 A1
(43) Pub. Date: May 13, 2021

(54) NOVEL COMPOSITIONS FOR BITTERANTS

(71) Applicant: UPL LTD, Haldia (IN)

(72) Inventors: Parasu Veera Uppara, Mumbai (IN); Nitin Ramdas Patil, Mumbai (IN); Ankit Singh, Mumbai (IN); Krishna Ramprakash Srivastava, Mumbai (IN); Jaidev Rajnikant Shroff, Dubai (AE); Vikram Rajnikant Shroff, Dubai (AE)

(21) Appl. No.: 17/257,620

(22) PCT Filed: Jul. 4, 2019
(86) PCT No.: PCT/IB2019/055718

§ 371 Date: Jan. 4, 2021

(30) Foreign Application Priority Data
Jul. 5, 2018 (IN) 201831025216

(51) Int. Cl. C08K 5/20; C08K 5/09; C08J 3/215; C08F 126/06; C08F 271/02; C08K 5/47

(52) U.S. Cl. CPC C08K 5/20; C08K 5/09; C08J 3/215; C08J 2351/00; C08F 271/02; C08K 5/47; C08J 2339/08; C08F 126/06

(57) ABSTRACT

The present invention relates to compositions comprising aversive agent. More specifically, the present invention relates to polymer composite compositions comprising such agents and application thereof.

### TECHNICAL FIELD

The present invention relates to a composition comprising aversive agent and process of preparation thereof. More specifically, the present invention relates to polymer composite compositions comprising such agents and method of use thereof.

### BACKGROUND OF INVENTION

Denatonium Benzoate is a versatile compound with uses ranging from denaturation in alcohol to aversive agent added to various products ranging from pharmaceuticals, cables, agrochemicals, perfumes as well as various other industries. Denatonium Benzoate is known to be the bitterest compound and is used for its bitter properties as an aversive agent. Denatonium Benzoate is known to be added to various materials.

U.S. Pat. No. 6,468,554 teach the addition of Denatonium Benzoate to plastic polymers such as polyvinyl chloride. EP0318262 discloses a liquid formulation of denatonium benzoate with surfactants. The liquid formulations are said to be easier to dissolve in a hydrocarbon. WO9301712 teaches the use of Denatonium Benzoate as a rodenticide. US20140371411 teaches chemical coupling of the aversive agent to water soluble polymers to prevent accidental ingestion of single detergent pods by children. The drawback of the polymer used is that it is water soluble and has limited stability, therefore not suitable for use in other applications.

There are various issues related to Denatonium Benzoate, such as handing the compound as well as reducing accidental mixing etc. Denatonium benzoate is used in a wide range of products. It is generally used in lower concentrations of 0.05% which is not known to irritate the skin. However, at larger concentrations handling is a problem.

There is therefore a need in the art for a composition of aversive agent, wherein, the composition preserves the activity whilst enhancing ease of handling, transporting and compatible blending with carrier material to explore it for various applications.

Therefore, it is an object of the present invention to provide a composition comprising Denatonium Benzoate and an inert carrier material, and to provide an inert carrier material that does not affect the activity of Denatonium Benzoate.

Another object of the present invention is to provide an inert carrier material that allows for better blending and availability of Denatonium Benzoate, whereby reducing the amount of Denatonium Benzoate used.

Some or all these and other objects of the invention can be achieved by way of the invention described hereinafter.

### SUMMARY OF THE INVENTION

Therefore, in one aspect, the present invention can provide a composition comprising at least one aversive agent and an inert carrier.

In another aspect, the present invention can provide a composition comprising Denatonium Benzoate and an inert carrier.

Another aspect of the present invention can provide a method of entrapping Denatonium Benzoate into an inert carrier polymeric matrix. This provides an opportunity to synthesize denatonium benzoate-polymer matrix in both in-situ and ex-situ way.

### BRIEF DESCRIPTION OF THE DRAWINGS

FIG. 1 represents differential scanning calorimetry (DSC) of sample product obtained from example 2. It shows phase transfer of the polymer-DB composite, initial softening of the polymer at 73° C., an endotherm at 170° C. is due to the entrapment of DB in the polymer. The endotherms at 311° C. and 387° C. are new peaks observed in the PVP_DB composites.

FIG. 2 represents Thermogravimetric analyses (TGA) of sample product obtained from example 2. It shows that the polymer composite of present invention is exhibits thermal stability without degradation up to 200° C. (>95%) after that decomposition started and complete decomposition took place above 300° C.

FIG. 3 represents scanning electron micrograph (SEM) image of sample product obtained from example 2 (300% w/w of 4-VP) of DB in the polymer matrix). It shows homogeneity in the composite formation.

FIG. 4 represents differential scanning calorimetry (DSC) of sample product obtained from example 6. It shows phase transfer of the polymer-DB composite, initial softening of the polymer at 64° C., 2nd endotherm at 97° C. and third small endotherm is at 295° C.

FIG. 5 represents Thermogravimetric analyses (TGA) of sample product obtained from example 6. It shows loss of 7.0% corresponds to the loss of residual solvent.

The polymer composite showed thermal stability without degradation up to 280° C. (>90%) after that decomposition started. It shows that as the % of polymer increases in the composite the thermal stability of the composite also increases.

FIG. 6 represents scanning electron micrograph (SEM) image of sample product obtained from example 6 (5% w/w of 4-VP) of DB in the polymer matrix). It shows homogeneity in the composite formation.

FIG. 7 represents differential scanning calorimetry (DSC) of sample product obtained from example 8. It shows phase transfer of the polymer-DB composite, initial softening of the polymer at 93° C., 2nd small endotherm at 254° C. and third big endotherm is at 379° C.

FIG. 8 represents Thermogravimetric analyses (TGA) of sample product obtained from example 8. It shows loss of −2.0% corresponds to the loss of residual solvent. The polymer composite showed thermal stability without degradation up to 260° C. (>90%) after that decomposition started. It shows that as the % of polymer increases in the composite the thermal stability of the composite also increases.

FIG. 9 represents scanning electron micrograph (SEM) image of sample product obtained from example 8. It shows homogeneity in the composite formation.

### DETAILED DESCRIPTION OF THE INVENTION

For the purposes of the following detailed description, it is to be understood that the invention may assume various alternative variations and step sequences, except where expressly specified to the contrary. Moreover, other than in any operating examples, or where otherwise indicated, all numbers expressing, for example, quantities of materials/ingredients used in the specification are to be understood as being modified in all instances by the term “about”. As used herein, the term “about” means that the numerical value is approximate and small variations would not significantly affect the practice of the disclosed embodiments. Where a numerical limitation is used, unless indicated otherwise by the context, “about” means the numerical value can vary by ±10% and remain within the scope of the disclosed embodiments.

In an aspect of the present invention provides a composition comprising at least one aversive agent and an inert carrier.

In an embodiment, the aversive agent is Denatonium benzoate.

Therefore, in this aspect, the present invention provides a composition comprising Denatonium benzoate and an inert carrier.

The present inventors have found that Denatonium benzoate, when linked with an inert carrier, allows for better handling, transporting and retaining solubility in various solvents such as methanol, ethanol and dichloromethane. The term “linked” with an inert carrier in the context of the present invention means the chemical or physical interaction taking place between the aversive agent, preferably denatonium benzoate, and the inert carrier when the two are brought together within the same composition, It may also mean entrapping the denatonium benzoate inside the polymer matrix. The precise nature of these interactions are not known, and are not limiting as well. However, when an inert carrier brought in intimate contact with aversive agent, it has been found that the resulting physico-chemical changes in the aversive agent, for example in denatonium benzoate, renders it more suitable for use in commerce.

In an embodiment, inert carrier is a film forming polymer.

Accordingly, the intimate mixture of the aversive agent and the film forming polymer within the composition results into the entrapment of the aversive agent into the polymeric matrix.

In an embodiment the polymeric matrix is thin film.

This polymeric matrix entrapping the aversive agent then releases the aversive agent sustainably over a period of time to provide a controlled benefit of administering such aversive agent in the particular environment of its use.

Therefore, a careful selection of the polymeric matrix allows the entrapped aversive agent to be used in a variety of environments depending on the needs and the selection of the polymeric matrix.

For example, denatonium benzoate may be entrapped within the polymeric matrix of an inert used in any of the preferred environments of its use, and used in applications such as for denaturation of alcohol, in antifreeze, in nail biting preventions, in respirator mask fit-testing, in animal repellents, in liquid soaps and shampoos, in discouraging consumption of harmful alcohols like methanol, and additives like ethylene glycol or in rubbing alcohol, in harmful liquids including solvents such as nail polish remover, paints, varnishes, toiletries and other personal care items, and various other household products, including its use in animal repellents, especially for large mammals as deer, to safeguard rat poisons from human consumption and so on.

Therefore, the composition of the present invention adapts the aversive agent, particularly denatonium benzoate, to be capable of being used in any environment of its use depending upon the selection of the inert film forming polymer. The selection of the film forming polymer, and of thus the film forming polymeric matrix for entrapping denatonium benzoate, may in turn be based on the targeted environment of intended use or its commercial application.

In an embodiment, the present invention thus provides a composition comprising at least one aversive agent and at least one film forming polymer, wherein the aversive agent is at least partially entrapped within or coated by said film forming polymeric matrix.

In an embodiment, the aversive agent is Denatonium benzoate.

In an embodiment, the aversive agent is Denatonium saccharide.

Thus, in this embodiment, the present invention thus provides a composition comprising denatonium benzoate and at least one film forming polymer, wherein the denatonium benzoate is at least partially entrapped within or coated by said film forming polymeric matrix. The physical properties of the film such as flexibility, thermal stability, texture can be tailor made by varying % of aversive agent and such modulated film can be explored for possible applications.

Therefore, by modulating the selection of the polymeric matrix used to entrap denatonium benzoate, the composition of the present invention may be used for different applications such as antifreeze, windshield washer, car cleaner, car polish, degreaser, brake fluid, air freshener, kitchen cleaner, bathroom cleaner, liquid detergent, fabric softeners, stain removers, glass cleaner, rodent killer, slug and snail bait, liquid fertilizer, herbicides, insecticides, wild animal repellents, nail polish remover, hand sanitizer, hair dyes, candles, material for wrappers/plastics to protect it from rodent attack and liquid pot-pourri.

It has been surprisingly found by the present inventors that the use of an inert polymer, particularly a film forming inert polymer, when used in conjunction with an aversive agent, preferably denatonium benzoate, improves its handling, transporting and retaining solubility in various solvents such as methanol, ethanol, dichloromethane dimethylformamide. The use of an inert polymer of the present invention can reduce or eliminate the need for careful handling of Denatonium benzoate.

The use of inert polymers with taste masking agents may be used in pharmaceutical applications for masking the bitter taste of actives or in the case of addictive drugs, addition of aversive agents to deter addiction may be practiced.

The inert polymers used can be polysaccharides or cyclodextrins.

In an embodiment, the inert carrier in compositions of the present invention are such that the homopolymers along with Denatonium benzoate form films that are easier to handle and which are also easy to transport. It was thus surprising to the present inventors that when such film forming polymers were polymerized with Denatonium, an easy to handle composition was obtained, which also had a, better stability as well as improved spectrum of applications. As will be demonstrated in the examples, when incorporated within other material such as agrochemical compositions, plastic formulations, pharmaceuticals etc., the mixing and handling of Denatonium benzoate was found to be superior as compared to when used without inert polymers. The use of inert polymers helps in reducing any residue of Denatonium benzoate, thereby reducing the amount of Denatonium benzoate to be used.

Thus, in an embodiment, the inert carrier may be selected from but not limited to inert film forming polymers such as cellulose ethers, or acrylic polymers and copolymers, as well as high molecular weight polyethylene glycols, Hydroxypropyl methylcellulose phthalate (HPMCP), polyvinyl alcohol, polyvinyl pyrrolidine, vinyl pyridine Polymers such as polymer of 2-Vinylpyridine (2-VP), 3-Vinylpyridine (3-VP), and 4-Vinylpyridine (4-VP), Crosslinked polymers of 4-Vinylpyridine and Divinyl benzene, Oligomer of Epichlorohydrin and 4-vinylpyridine, Polyvinyl pyridine-chloromethylated polystyrene polymers, 4-Vinylpyridine-Ethylene glycol dimethacrylate(EGDMA) crosslinked polymer, poly(4-vinyl pyridine-costyrene)/FHAP nanocomposite, Poly(4-vinylpyridine-Co-N-allylthiourea), and poly(acrylamide-co-4-vinylpyridine) hydrogels.

In an embodiment, the present invention thus provides a composition comprising at least one aversive agent and at least one inert carrier, wherein the aversive agent is at least partially entrapped within or coated by said inert carrier selected from the group consisting of cellulose ethers, or acrylic polymers and copolymers, as well as high molecular weight polyethylene glycols, Hydroxypropyl methylcellulose phthalate (HPMCP), polyvinyl alcohol, polyvinyl pyrrolidine, vinyl pyridine Polymers such as polymer of 2-Vinylpyridine (2-VP), 3-Vinylpyridine (3-VP), and 4-Vinylpyridine (4-VP), Crosslinked polymers of 4-Vinylpyridine and Divinyl benzene, Oligomer of Epichlorohydrin and 4-vinylpyridine, Polyvinyl pyridine-chloromethylated polystyrene polymers, 4-Vinylpyridine-Ethylene glycol dimethacrylate(EGDMA) crosslinked polymer, poly(4-vinyl pyridine-costyrene)/FHAP nanocomposite, Poly(4-vinylpyridine-Co-N-allylthiourea), and poly(acrylamide-co-4-vinylpyridine) hydrogels.

In an embodiment, the aversive agent is Denatonium benzoate.

Thus, in this embodiment, the present invention provides a polymer composite comprising denatonium benzoate and at least polymer, wherein the denatonium benzoate is at least partially entrapped within or coated by said polymer selected from the group consisting of cellulose ethers, or acrylic polymers and copolymers, as well as high molecular weight polyethylene glycols, Hydroxypropyl methylcellulose phthalate (HPMCP), polyvinyl alcohol, polyvinyl pyrrolidine, vinyl pyridine Polymers such as polymer of 2-Vinylpyridine (2-VP), 3-Vinylpyridine (3-VP), and 4-Vinylpyridine (4-VP), Crosslinked polymers of 4-Vinylpyridine and Divinyl benzene, Oligomer of Epichlorohydrin and 4-vinylpyridine, Polyvinyl pyridine-chloromethylated polystyrene polymers, 4-Vinylpyridine-Ethylene glycol dimethacrylate(EGDMA) crosslinked polymer, poly(4-vinyl pyridine-costyrene)/FHAP nanocomposite, Poly(4-vinylpyridine-Co-N-allylthiourea), and poly(acrylamide-co-4-vinylpyridine) hydrogels.

In an embodiment, the preferred inert polymer may be homo-/crosslinked polymers of vinyl pyridine and derivatives thereof.

The concentration of denatonium benzoate in the composition is in the range from about used in the wt % range of about 0.01% to about 80% and inert carrier is used in the wt % range of about 10% to about 99.95%. Preferably the composite comprises about 4% to about 95% w/w of aversive agent to the polymer. The higher concentrations of denatonium benzoate are achieved in the present invention with improved stability and reduced amount of denatonium benzoate.

The polymer composite of the present invention is durable, thermostable and exhibit homogeneity in the formulation.

In an embodiment the particle size of the composite prepared according to the present invention is in the range of about 100 μm to about 2.0 mm. The particles can be further micronized by conventional techniques.

The choice of the aversive agent according to the present invention is not particularly limiting. In accordance with the present invention, the inert polymers of the composition may be readily combined with other aversive agents such as bitterants, or chemicals producing a bitter flavor. Examples of these may include Denatonium benzoate, Denatonium saccharide, Denatonium chloride, Denatonium Capsaicinate, Denatonium 4-vinylbenzoate, Sucrose octaacetate, Quinine, Quercetin, Brucine, Narigen, Quassin, Brucine and the like; pungent agents, chemicals producing an unpleasantly pungent flavor such as piperine, allyl isothiocynate, Resiniferatoxin, capsicinoids (including capsaicin); vanillyl ethyl ether; vanillyl propyl ether; vanillyl butyl ether; vanillin propylene; glycol acetal; ethylvanillin propylene glycol acetal; gingerol; 4-(1-menthoxymethyl)-2-(3′-methoxy-4′-hydroxy-phenyl)-1, 3-dioxolane; pepper oil; pepperoleoresin; gingeroleoresin; nonylic acid vanillylamide; jamboo oleoresin; Zanthoxylum piperitum peel extract; sanshool; sanshoamide; black pepper extract; chavicine; piperine; spilanthol; and mixtures thereof.

In a preferred embodiment, the aversive agent is denatonium benzoate.

In certain embodiments of the present invention the composite is prepared as free-flowing beads.

In certain embodiments of the present invention the composite is prepared as a polymer film.

In certain embodiments the present invention provides a method of using the composition of the present invention, said method comprising combining denatonium benzoate with an inert homopolymer such that it forms a film, and adding the film to a desired substrate.

In an embodiment, the desired substrate can be selected from but not limited to use in plastic such molten flexible polyvinyl chloride, polyamides, polycarbonates, polyesters, polyethene derivatives, polypropylene, polyethylene, Polyvinyl-alcohol, polystyrene and its derivative, polyvinylidene chloride, polyurethane, Polyvinylidene chloride (PVDC), Acrylonitrile butadiene styrene (ABS), Polyepoxide, Polymethyl methacrylate, Polytetrafluoroethylene, phenol formaldehyde, melamine formaldehyde, urea-formaldehyde, polyetheretherketone, maleimide/bismaleimide, polyetherimide, polyimide, plastarch material, polylactic acid, furan, silicone, polysulfone and mixtures thereof.

An aspect of the present invention may provide a method comprising combining denatonium benzoate with an inert homopolymer such that the denatonium benzoate is at least partially entrapped within the polymeric matrix and adding the composition to a desired substrate.

In an embodiment, the composition of the present invention may be added in larger quantities to master batches.

In an embodiment, the desired substrate maybe an agrochemical formulation such as those selected from but not limited to wettable powders, granules, dusts,

Soluble (liquid) concentrates, suspension concentrates, oil in water emulsion, water in oil emulsion, emulsifiable concentrates, capsule suspensions, ZC formulations, oil dispersions or other known formulation types. Thus, in a preferred embodiment, the substrate can be used along with herbicide, pesticide, insecticide, rodenticide to explore and enhance its application efficacy.

In this embodiment, the composition of the present invention may be used to prepare agrochemical formulations that, by their bitter taste, prevent unintended or intended misuse of such agrochemical formulations.

In an embodiment, the desired substrate may be a rodenticide formulation or a veterinary formulation.

In an embodiment, the substrate is a paint formulation.

In an embodiment, the substrate is a detergent formulation such as gel based, solid or liquid formulations, pods, sachets etc.

In an embodiment, the substrate is a perfume formulation.

In an embodiment, the substrate is a pharmaceutical formulation such as drugs which are controlled substances.

In an embodiment, the substrate is a film that wraps around saplings preventing chewing and gnawing of smaller animals.

In an embodiment, the substrate is alcohol that needs to be denatured.

In an embodiment, the substrate is a fuel such as kerosene, petrol, diesel, as well as other known fuels.

In an embodiment, the substrate is an antifreeze composition.

In an embodiment, the substrate is an animal repellant composition.

In an embodiment, the substrate can be modulated by it's way of in-situ and ex-situ synthesis to explore applications.

A person skilled in the art could readily envision other uses of the present composition in other substrates not mentioned herein.

The compositions envisioned in the present invention are thermostable and can therefore, be used on a wide variety of substrates without any modification. The inert polymer of the present invention has an excellent solubility in a range of solvents including but not limited to ethanol, methanol, as well as green fuels. The ease of handling of the composition makes it ideal to handle in larger quantities if required. The inert polymer of the composition may also be found to be compatible with formulation aids, solvents, dispersion agents, surfactants, and the like.

As will be described in the examples, the present invention has many advantages over past handling of aversive agents. The foremost is the ease of handling the agent, which leaves a bitter prevalent taste in the mouth of the handler as well as other people in the environs. Another advantage is the high compatibility of the composition thus prepared, which is readily soluble in a wide variety of substrates.

Another advantage is the thermal stability of the present composition as well as the long shelf life of the composition.

### EXAMPLES

The aversive agents of the present invention were formulated with various inert polymers and studied for thermal stability, dissolution, taste, and shelf life.

### Example 1

### Synthesis of Homopolymer of Poly(4-vinylpyridine) (PVP)

To boiling methanol (50 mL) taken in a 250 mL three necked flask, equipped with a condenser and a dropping funnel, a solution of 4-vinylpyridine (40 g) and AlBN (1 g) was added dropwise with stirring over 1 h. The flask was kept at 65° C. to 70° C. for additional 3 h. The solution was concentrated to half its volume on a rotavac under reduced pressure at 65° C. The solution was cooled to room temperature and was gradually added with stirring to diethyl ether (100 mL) to precipitate the polymer. The polymer was washed 3-4 times with diethyl ether to remove traces of unreacted 4-VP. The polymer appeared as a pink colored powdery mass.

### Example 2

### Synthesis of Poly(4-vinylpyridine) (PVP) homopolymer and in-situ Entrapment/Blending of 300% w/w (w.r.t. wt. of 4-VP) of denatonium benzoate in the polymer matrix

To the 250 mL of glass kettle equipped with condenser, dropping funnel and mechanical stirrer, 60 g of Denatonium benzoate and 60 mL of methanol was added. The reaction mass was heated to 65° C.-70° C. with stirring and maintained for 30 min. To the above clear solution, a mixture of 4-Vinylpyridine (20 g) and AlBN (0.5 g) was added slowly with stirring for 1 h. After addition of mixture, the reaction mass was maintained at the same temperature for additional 3 h. The hot reaction mass then transferred in Petri dish and evaporated at RT (25-30° C.) followed by vacuum at 50° C. to get DB-PVP blended mass. 73 g of polymer was obtained; Colour of product: Dark brown. The polymer was bitter to taste.

### Example 3

### Synthesis of Poly(4-vinylpyridine) (PVP) homopolymer and in-situ Blending of 100% w/w (w.r.t. wt. of 4-VP) of DB in the polymer matrix

To the 250 mL of glass kettle equipped with condenser, dropping funnel and mechanical stirrer, 20 g of Denatonium benzoate and 60 mL of methanol was added. The reaction mass was heated to 70° C. with stirring and maintained for 30 min. To the above clear solution a mixture of 4-Vinylpyridine (20 g) and AlBN (0.5 g) was added slowly with stirring for 1 h. After addition of mixture, the reaction mass was maintained at the same temperature for additional 3.0 h. The hot reaction mass then transferred in Petri dish and evaporated at RT (25° C.-30° C.) followed by vacuum at 50° C. to get DB-PVP blended mass. The powder then stored in container at room temperature. 38g of polymer matrix was obtained.

### Example 4

### Synthesis of Poly(4-vinylpyridine) Crosslinked with divinylbenzene [P(VP-DVB)] polymer and in-situ Blending of 50% w/w (w.r.t. wt. of 4-VP) of DB in the polymer matrix

To the 250 mL of glass kettle equipped with condenser, dropping funnel and mechanical stirrer, 10 g of Denatonium benzoate and 60 mL of water was added. The reaction mass was heated to 70° C.-80° C. with stirring and maintained for 30 min. To the above clear solution, a mixture of 4-Vinylpyridine (20 g), Divinylbenzene (1.24 g) and AlBN (0.8 g) was added slowly. After addition of mixture, the reaction mass was maintained at the same temperature for additional 7 h. The reaction mass cooled to RT (25° C.-30° C.) and 40.0 mL of water was added. The free-flowing bead like mass stirred for 1 h and then filtered and bed-washed with 50 mL of water under vacuum. The DB-PVP-DVB crosslinked beads dried under vacuum at RT followed by 50° C. under vacuum.

### Example 5

### Synthesis of Poly(4-vinylpyridine) (PVP) homopolymer and in-situ Blending of 50% w/w (w.r.t. wt. of 4-VP) of DB in the polymer matrix

To the 250 mL of glass kettle equipped with condenser, dropping funnel and mechanical stirrer, 10 g of Denatonium benzoate and 60 mL of methanol was added. The reaction mass was heated to 70° C. with stirring and maintained for 30 min. To the above clear solution, a mixture of 4-Vinylpyridine (20 g) and AlBN (0.5 g) was added slowly with stirring for 1 h. After addition of mixture, the reaction mass was maintained at the same temperature for additional 3.0 h. The hot reaction mass then transferred in Petri dish and evaporated at RT (25-30° C.) followed by vacuum at 50° C. to get DB-PVP blended mass. The powder then stored in container at room temperature. 28.0 g (Yield=93.33%) of polymer matrix was obtained.

### Example 6

### Synthesis of Poly(4-vinylpyridine) (PVP) homopolymer and in-situ Blending of 5% w/w (w.r.t. wt. of 4-VP) of DB in the polymer matrix

To the 250 mL of glass kettle equipped with condenser, dropping funnel and mechanical stirrer, 1 g of Denatonium benzoate and 60 mL of methanol was added. The reaction mass was heated to 70° C. with stirring and maintained for 30 min. To the above clear solution, a mixture of 4-Vinylpyridine (20 g) and AIBN (0.5 g) was added slowly with stirring for 1 h. After addition of mixture, the reaction mass was maintained at the same temperature for additional 3 h. The hot reaction mass then transferred in Petri dish and evaporated at RT (25° C.-30° C.) followed by vacuum at 50° C. to get DB-PVP blended mass. The powder then stored in container at room temperature. 20 g (95%) of polymer matrix was obtained.

### Example 7

### Synthesis of Poly(4-vinylpyridine) Crosslinked with divinylbenzene [P(VP-DVB)] polymer and in-situ Blending of 50% w/w (w.r.t. wt. of 4-VP) of Denatonium benzoate DB in the polymer matrix

To the 250 mL of glass kettle equipped with condenser, dropping funnel and mechanical stirrer, 10 g of Denatonium benzoate and 60 mL of methanol was added. The reaction mass was heated to 70° C.-80° C. with stirring and maintained for 30 min. To the above clear solution, a mixture of 4-Vinylpyridine (20 g), Divinylbenzene (1.24 g) and AlBN (0.8 g) was added slowly. After addition of mixture, the reaction mass was maintained at the same temperature for additional 7 h. The reaction mass cooled to RT (25° C.-30° C.) and 40 mL of methanol was added. The free-flowing bead like mass stirred for 1 h and then filtered and bed-washed with 50 mL of methanol under vacuum. The DB-PVP-DVB crosslinked beads dried under vacuum at RT followed by 50° C. under vacuum. The DB-PVP-DVB crosslinked blended mass dried under vacuum at RT followed by 65° C. under vacuum. The mass then stored in container at room temperature. 26 g (83.22%) of polymer matrix was obtained.

### Example 8

### Synthesis of Poly(4-vinylpyridine) (PVP) homopolymer and in-situ Blending of 5% w/w (w.r.t. wt. of 4-VP) of Denatonium saccharide (DS) in the polymer matrix

To the 250 mL of glass kettle equipped with condenser, dropping funnel and mechanical stirrer, 2.5 g of Denatonium saccharide and 150 mL of methanol was added. The reaction mass was heated to 65° C.-70° C. with stirring and maintained for 30 min. To the above clear solution, a mixture of 4-Vinyl pyridine (50g) and AlBN (1.25 g) was added slowly with stirring for 1 h. After addition of mixture, the reaction mass was maintained at the same temperature for additional 3 h. The hot reaction mass then transferred in Petri dish and evaporated at RT (25° C.-30° C.) followed by vacuum at 65° C. to get DS-PVP blended mass. The powder then stored in container at room temperature. 44.62 g (Yield=85.0%) of polymer matrix was obtained.

### Example 9

### Synthesis of Poly(4-vinylpyridine) (PVP) homopolymer and in-situ Blending of 100% w/w (w.r.t. wt. of 4-VP) of Denatonium saccharide (DS) in the polymer matrix

To the 250 mL of glass kettle equipped with condenser, dropping funnel and mechanical stirrer, 50 g of Denatonium saccharide and 150 mL of methanol was added. The reaction mass was heated to 65° C.-70° C. with stirring and maintained for 30 min. To the above clear solution, a mixture of 4-Vinyl pyridine (50 g) and AlBN (1.25 g) was added slowly with stirring for 1 h. After addition of mixture, the reaction mass was maintained at the same temperature for additional 3.0 h. The hot reaction mass then transferred in Petri dish and evaporated at RT (25° C.-30° C.) followed by vacuum at 50° C. to get DS-PVP blended mass. The powder then stored in container at room temperature. 90 g (Yield=90%) of polymer matrix was obtained.

### Example 10

### Synthesis of Poly(4-vinylpyridine) (PVP) homopolymer and in-situ Blending of 50% w/w (w.r.t. wt. of 4-VP) of Denatonium saccharide (DS) in the polymer matrix

To the 250 mL of glass kettle equipped with condenser, dropping funnel and mechanical stirrer, 25 g of Denatonium saccharide and 150 mL of methanol was added. The reaction mass was heated to 65° C.-70° C. with stirring and maintained for 30 min. To the above clear solution, a mixture of 4-Vinylpyridine (50 g) and AIBN (1.25 g) was added slowly with stirring for 1 h. After addition of mixture, the reaction mass was maintained at the same temperature for additional 3 h. The hot reaction mass then transferred in Petri dish and evaporated at RT (25° C.-30° C.) followed by vacuum at 50° C. to get DS-PVP blended mass. The powder then stored in container at room temperature. 65.25 g (Yield=87%) of polymer matrix was obtained.

### Example 11

### Synthesis of Poly(4-vinylpyridine) (PVP) homopolymer and in-situ Entrapment/Blending of 300% w/w (w.r.t. wt. of 4-VP) of Denatonium saccharide (DS) in the polymer matrix

To the 250 mL of glass kettle equipped with condenser, dropping funnel and mechanical stirrer, 150 g of Denatonium saccharide and 150 mL of methanol was added. The reaction mass was heated to 65° C.-70° C. with stirring and maintained for 30 min. To the above clear solution, a mixture of 4-Vinylpyridine (50 g) and AlBN (1.25 g) was added slowly with stirring for 1 h. After addition of mixture, the reaction mass was maintained at the same temperature for additional 3 h. The hot reaction mass then transferred in Petri dish and evaporated at RT (25° C.-30° C.) followed by vacuum at 50° C. to get DS-PVP blended mass. 186 g (93% Yield) of polymer was obtained. The polymer was bitter to taste.

### Example 12

### Synthesis of Polyvinyl Alcohol (PVA)-5% w/w (w.r.t. wt. of PVA) Denatonium benzoate (DB) Composite

To the 250 mL of glass kettle equipped with condenser and mechanical stirrer, 2.5 g of Denatonium benzoate and 80 mL of water was added. The reaction mass was heated to 65° C.-70° C. with stirring and maintained for 30 min. To the above clear solution, Polyvinyl alcohol (50 g) was added slowly with stirring for 30 Min. After addition of mixture, the reaction mass was maintained at the same temperature for additional 3 h. The reaction mass was concentrated under vacuum at 65° C. to get DB-PVA blended mass. The powder then stored in container at room temperature. 47.25 g (Yield=90%) of polymer matrix was obtained;

### Example 13

### Synthesis of Poly(4-vinylpyridine) (PVP) homopolymer and in-situ Blending of 5% w/w (w.r.t. wt. of 4-VP) of Denatonium Capsaicinate (DC) in the polymer matrix

To the 250 mL of glass kettle equipped with condenser, dropping funnel and mechanical stirrer, 2.5 g of Denatonium Capsaicinate (DC) and 150 mL of methanol was added. The reaction mass was heated to 65° C.-70° C. with stirring and maintained for 30 min. To the above solution, a mixture of 4-Vinylpyridine (50 g) and AlBN (1.25 g) was added slowly with stirring for 1 h. After addition of mixture, the reaction mass was maintained at the same temperature for additional 3 h. The hot reaction mass then transferred in Petri dish and evaporated at RT (25° C.-30° C.) followed by vacuum at 65° C. to get DC-PVP blended mass. The powder then stored in container at room temperature. 45.67 g (Yield=87.0%) of polymer matrix was obtained.

1. A composition comprising at least one aversive agent and at least one inert polymer carrier, wherein the aversive agent is at least partially embedded within said inert polymer carrier.

2. The composition as claimed in claim 1, wherein said aversive agent is selected from the group consisting of denatonium salts, denatonium benzoate, denatonium saccharide, denatonium chloride, denatonium 4-vinylbenzoate, denatonium capsaicinate, sucrose octaacetate, quinine, quercetn, brucine, narigen, quassin, brucine, a pungent agent, piperine, allyl isothiocynate, resiniferatoxin, a capsicinoids, vanillyl ethyl ether; vanillyl propyl ether, vanillyl butyl ether, vanillin propylene, glycol acetal, ethylvanillin propylene glycol acetal, gingerol, 4-(1-menthoxymethyl)-2-(3′-methoxy-4′-hydroxy-phenyl)-1, 3-dioxolane, pepperoleoresin, gingeroleoresin, nonylic acid vanillylamide, and mixtures thereof.

3. The composition as claimed in claim 2, wherein said inert polymer carrier is selected from the group consisting of cellulose ethers, acrylic polymers, acrylic copolymers, high molecular weight polyethylene glycols, hydroxypropyl methylcellulose phthalate (HPMCP), polyvinyl alcohol, polyvinyl pyrrolidine, a polymer of 2-vinylpyridine (2-VP), a polymer of 3-vinylpyridine (3-VP), a polymer of 4-vinylpyridine (4-VP), a crosslinked polymers of 4-vinylpyridine and divinyl benzene, an oligomer of epichlorohydrin and 4-vinylpyridine, a polyvinylpyridine-chloromethylated polystyrene polymer, a 4-vinylpyridine-ethylene glycol dimethacrylate(EGDMA) crosslinked polymer, a poly(4-vinyl pyridine-costyrene)/FHAP nanocomposite, poly(4-vinylpyridine-Co-N-allylthiourea), and poly(acrylamide-co-4-vinylpyridine) hydrogel.

4. The composition as claimed in claim 2, wherein said inert polymer carrier is selected from the group consisting of homo-/crosslinked polymers of vinyl pyridine and derivatives thereof, a polymer of 2-vinylpyridine, a polymer of 3-vinylpyridine, a polymer of 4-vinylpyridine, and precursors thereof.

5. The composition as claimed in claim 1, wherein said aversive agent is selected from the group consisting of denatonium benzoate, denatonium saccharide and denatonium capsaicinate.

6. The composition as claimed in claim 1, wherein said aversive agent is in a concentration from about 0.01 to about 300% w/w based on a weight of the inert polymer carrier.

7. The composition as claimed in claim 1, wherein said aversive agent is in the wt % range of about 0.01% to about 80% and the inert polymer carrier is in the wt % range from about 10% to about 99.95%, based on the total weight of the composition.

8. The composition as claimed in claim 1, wherein said composition provides controlled release of the aversive.

9. A process for preparing a composite of an aversive agent and an inert polymer carrier, said process comprising:
a) treating the aversive agent with the polymer carrier in the presence of a solvent and an initiator to obtain the polymer composite; or
b) treating the aversive agent with a polymer carrier precursor in the presence of a solvent and an initiator to obtain the polymer composite; or
c) treating the aversive agent with a polymer carrier precursor in the presence of a crosslinking agent, a solvent and an initiator to obtain the polymer composite.

10. The process as claimed in claim 9, comprising heating a mixture of denatonium benzoate in the solvent and the polymer carrier or precursor of the polymer carrier in the presence of the initiator, and evaporating the solvent from the mixture to obtain the polymer composite.

11. The process as claimed in claim 10, wherein said process is carried out at 50 to 100° C.

12. An article comprising
a substrate; and
a polymer composite comprising at least one aversive agent and at least one inert polymer carrier, wherein the aversive agent is at least partially entrapped within or coated by said polymer composite which forms a film forming polymeric matrix on the substrate.

13. The article as claimed in claim 12, wherein said substrate is selected from the group consisiting of molten flexible polyvinyl chloride, polyamides, polycarbonates, polyesters, polyethene derivatives, polypropylene, polyethylene, polyvinyl-alcohol, polystyrene, polyvinylidene chloride, polyurethane, polyvinylidene chloride, acrylonitrile butadiene styrene, polyepoxide, polymethyl methacrylate, polytetrafluoroethylene, phenol formaldehyde, melamine formaldehyde, urea-formaldehyde, polyetheretherketone, maleimide/bismaleimide, polyetherimide, polyimide, plastarch material, polylactic acid, furan, silicone, polysulfone, and mixtures thereof.
